(19) United States
(12) Patent Application Publication
(10) Pub. No.: US 2002/0147745 A1
(43) Pub. Date: Oct. 10, 2002

(54) Method and apparatus for document markup language driven server

(76) Inventors: Robert Houben, Vancouver (CA); John S.D. Hunter, Vancouver (CA)

Correspondence Address: CHRISTIE, PARKER & HALE, LLP, 350 WEST COLORADO BOULEVARD, SUITE 500, PASADENA, CA, 91105, US

(21) Appl. No.: 09/832,319

(22) Filed: Apr. 9, 2001

(51) Int. Cl. G06F 15/00

(52) U.S. Cl. 707/513; 707/530

(57) ABSTRACT

A method and apparatus for processing an incoming document using a markup language driven server. Each of the processing operations are specified by personality and behavior documents written in a markup language. The documents are parsed into memory creating a tree structure. The processing of the incoming document is completed upon successfully parsing the personality and behavior documents.

### BACKGROUND OF THE INVENTION

This invention relates generally to document servers and more specifically to document servers integrated with legacy data systems.

Pre-Internet era businesses are struggling to integrate their businesses and existing legacy systems with the global communications network known as the Internet. (Many businesses originated in the pre-Internet era and automated their respective data processing needs prior to the development and wide-spread acceptance of the Internet. These pre-Internet systems are often referred to as legacy systems. Other entities have businesses that revolve primarily around the Internet; typically, such businesses originated during or after the dawning of the Internet age and are sometimes referred to herein as “Internet-era businesses”). Internet-era businesses are struggling with unrefined tools to develop, manage and control data collected and processed with their Internet-based systems. Both Pre-Internet era and Internet-era businesses are struggling to communicate with one another.

In some cases, the data structures used by legacy systems are not directly compatible with Internet data structures. Consequently, many enterprises with legacy systems face the task of converting data created and stored by their respective legacy systems to a form cognizable by Internet based systems for their respective emergence into electronic commerce (eCommerce), and for their interface with their respective Internet trading partners.

Additionally, eCommerce may comprise only a portion of an enterprise's entire business. Accordingly, data collected and processed on the Internet must be integrated with the data maintained on the enterprise's legacy systems.

Most automated systems, whether legacy or Internet, use some architectural scheme, which is expressed in a particular data structure, to organize the system's data. There are many different types of data structures. Legacy systems frequently use hierarchical or multivalued simple data structures with which to organize their respective data. Some legacy systems use relational simple data database management systems. In contrast to the data structures used by legacy systems, tree-based rich data structures comprise much of the data foundation for the Internet.

In contrast to the explicit organizational and descriptive intelligence contained in rich data structures, the organization and meaning of data items in simple data structures are often inherent to the order of the data, and/or require the intelligence of what is known as metadata or an application program to identify the beginning and end of, and impart meaning to, individual data items.

Metadata is data about data—it is high level data about the lower-level data contained in a particular file or data base. In some cases, such as is the case with multivalued data structures, low level metadata is implicit in the data which it describes. In other cases, such as is the case with certain Data Base Management Systems (DBMS), metadata describing the data base is contained within a data dictionary. Other examples of metadata include: record descriptions in a COBOL program, CASE entity relationship diagrams for a particular set of entities, and data server catalog logical view descriptions.

As a consequence of the absence of explicit metadata in simple data structures, conversion to tree-based rich data structures based on the source data alone may result in data loss.

In a tree-based rich data structure, a root node, also referred to as a mother or parent node, describes the most basic level of information about the data to which the root node pertains. For instance, a document level node is used to describe a document. Other nodes, referred to as “child” or “children” nodes, can be designated with some relation, either direct or indirect, to the root node. For instance, the root node may have one or more child nodes, each of which in turn has one or more child nodes, each of which in turn has multiple children nodes.

One of the predominant tools for the development and exchange of data in Internet-based systems is Extensible Markup Language (XML). XML was originally designed as a markup language for electronic documents. A mark up language such as XML uses certain defined delimiters and tag names to designate meaning and/or organization of marked text within an electronic document. As an example, a sample electronic document has as its title the words “This is the Title” and has as a single paragraph of text “This is the text.” Using an exemplary mark up language to mark up the electronic document, a start title delimiter/tag name (in this example, “<t>”) is inserted before the title text for an electronic document; an end title delimiter/tag name (in this example, “</t>”) is inserted after the title text. Similarly, a start paragraph delimiter/tag name (in this example, “<p>”) is inserted before the first letter of the first word of a particular paragraph; an end paragraph delimiter/tag name (in this example, “</p>”) is inserted after the last letter of the last word of the paragraph. The resulting marked up electronic document would be represented in memory as follows:

<t>This is the Title </t>

<p>This is the text.</p>

Internet development programmers have begun to use document mark up languages, such as XML, to develop and exchange many types of data collections, other than merely electronic documents (electronic documents are sometimes referred to herein as simply “documents”). XML is used to identify structures in such diverse applications as metadata description, vector graphic manipulation, eCommerce, and mathematical equation expression, to name just a few.

In addition to being a mark up language, XML is also what is known as a “meta language” in that it provides for the explicit declaration of new Document Type Definitions (DTD)—that is, it provides development programmers with the ability to define program-specific tag names. Because of the DTD declaration capability of XML, each business may independently develop its own XML structures and tags. A particular strategy for marking up a document with tag names, naming conventions, delimiters and/or document structures is referred to herein as a “mark up schema” or simply “schema”.

An electronic document, or other collection of data (data collection), that has been marked up, such as with XML delimiters and tag names, is referred to as a marked up document; in the case of XML, as an XML document. Application programs are typically designed to access, navigate and manipulate marked up documents in tree-based form. Application programs access XML documents through a Document Object Model (DOM). A DOM is a machine-readable tree-based representation of an XML document. A type of program sometimes referred to as a document parser (in the case of XML, as an XML parser) provides a translation interface between the marked up document and the machine readable tree-based representation of that marked up electronic document.

The structural elements and DTD capabilities of XML and DOM enable the development of tree-based rich data structures. Notwithstanding the fact that many Internet developers are using XML and other mark up languages to define data structures for Internet applications, the tools, such as DOM, that are available to create, navigate and maintain tree-based rich data structures are cumbersome and difficult to use.

Without specially designed technology, the job of converting data without data loss from legacy systems to Internet-cognizable tree-based data structures can be a complex, resource-intensive project for any company tackling the job; the job is one that, with existing tools, requires highly-detailed, fact-specific program coding. Furthermore, without better, more effective tree-based rich data structure navigational tools, the creation, navigation, maintenance, and accessing of data between multiple Internet enterprises will remain difficult and time consuming.

Technology is therefore required to facilitate the resource efficient conversion of data created by legacy systems to a form useful to Internet-based programs and to facilitate the integration of the converted data with data existing in the Internet environment. Technology is further required to facilitate the resource efficient conversion of Internet data to simple data structures with which legacy systems can communicate and to facilitate the integration of the converted data with existing legacy system data. Technology is still further required to facilitate the resource efficient creation, navigation, maintenance, and accessing of data between multiple Internet enterprises.

Another aspect of Legacy-Internet transitions is the investment many companies have made in their respective legacy systems. Companies that have made such an investment and which also want to gain the benefits of the latest Internet technology, marketing and business opportunities, need a way to leverage the existing legacy system application software. Accordingly, some means is required that can expose (the term “expose” is used herein to mean “make available for access”, “make accessible” and/or “access”) the software capability and functionality of legacy system application software.

### SUMMARY OF THE INVENTION

In one aspect of the invention, a data processing system is adapted to process documents received from a client via a communication network. The data processing system receives an incoming document sent by a client via a communications network. The data processing system invokes a director software object that selects processing instructions for the incoming document. The data processing system then invokes a dispatcher and the dispatcher processes the incoming document according to the selected processing instructions.

In another aspect of the invention, a method is provided for processing a document received from a client via a communication network. At least one behavior document is provided including processing instructions. An incoming document is received from the client via the communication network. A personality document provides behavior document selection instructions for selecting a behavior document based on the incoming document and translation document selection instructions for selecting a translation document based on the incoming document. A translation document is selected using the personality document translation document selection instructions and the incoming document. The incoming document is translated into a working document using the selected translation document. A behavior document selected using the personality document behavior document selection instructions and the incoming document. The working document is then processed according to the processing instructions in the selected behavior document.

### BRIEF DESCRIPTION OF THE DRAWINGS

These and other features, aspects, and advantages of the present invention will become better understood with regard to the following description, appended claims, and accompanying drawings where:

FIG. 1 is a deployment diagram of an embodiment of an exemplary Internet based system for accessing legacy data;

FIG. 2 is a diagram of the architecture of an embodiment of a general purpose computer capable of serving as a host for the software objects depicted in FIG. 1;

FIG. 3 is a sequence diagram of an embodiment of a communication sequence between the software objects of FIG. 1;

FIG. 4 depicts data flow diagrams for an embodiment of a legacy data adapter and Internet data transformer objects;

FIG. 5 is a depiction of an embodiment of a DOM object encapsulating a DOM and exposing methods for operations on the DOM;

FIG. 6 is a class diagram for an embodiment of a business server;

FIG. 7 is a cooperation diagram depicting the operations in an embodiment of a business server during an embodiment of a business transaction;

FIG. 8 is a sequence diagram of an embodiment of a business transaction;

FIG. 9 is an embodiment of a personality document for a business server according to the present invention;

FIG. 10 is an embodiment of a behavior document for a business server according to the present invention;

FIG. 11 is an embodiment of a DASL action definition;

FIG. 12 is an embodiment of a database rules document according to the present invention;

FIG. 13 is an embodiment of a RASL action for a server behavior document;

FIG. 14 is an embodiment of a RPC rules document according to the present invention; and

APPENDIX A is a definition of actions used within an embodiment of a behavior document.

### DETAILED DESCRIPTION OF THE INVENTION

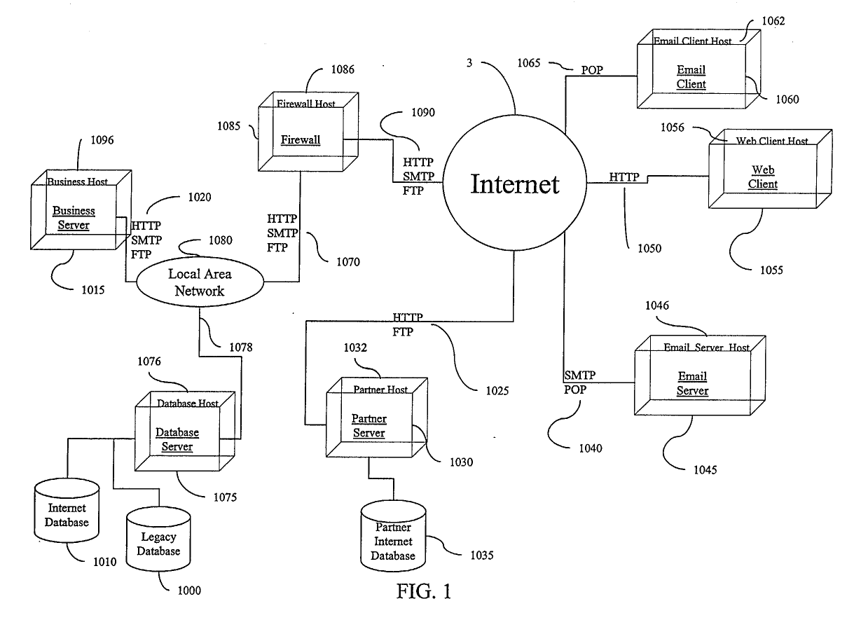

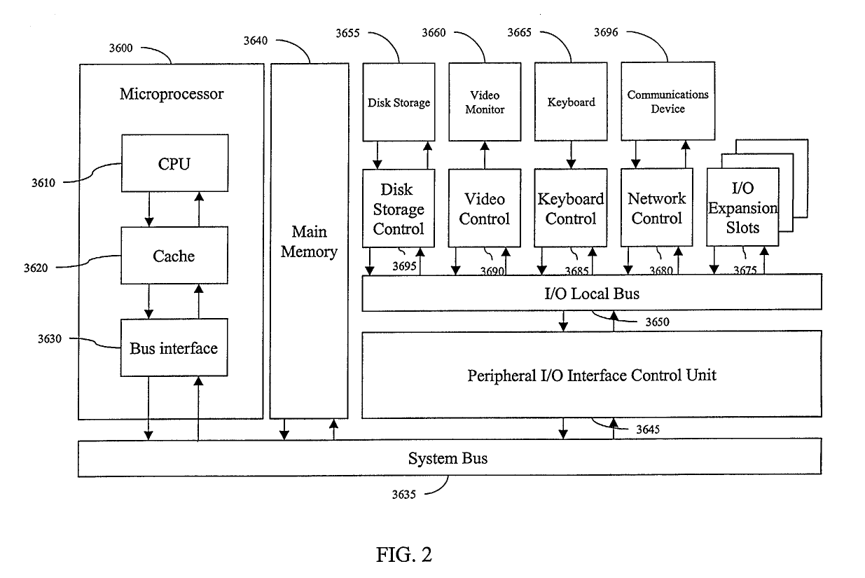

FIG. 1 is a deployment diagram of an exemplary implementation of a system facilitating the use of legacy data within Internet based transactions. The deployment diagram depicts a network of software objects with each software object deployed on a host. Each host is a general purpose computer as depicted in FIG. 2.

FIG. 2 is a hardware architecture diagram of a general purpose computer suitable for use as a software object host. Microprocessor 3600, comprised of a Central Processing Unit (CPU) 3610, memory cache 3620, and bus interface 3630, is operatively coupled via system bus 3635 to main memory 3640 and I/O control unit 3645. The I/O interface control unit is operatively coupled via I/O local bus 3650 to disk storage controller 3695, video controller 3690, keyboard controller 3685, and communications device 3680. The communications device is adapted to allow software objects hosted by the general purpose computer to communicate via a network with other software objects. The disk storage controller is operatively coupled to disk storage device 3625. The video controller is operatively coupled to video monitor 3660. The keyboard controller is operatively coupled to keyboard 3665. The network controller is operatively coupled to communications device 3696.

Computer program instructions implementing a software object are stored on the disk storage device until the microprocessor retrieves the computer program instructions and stores them in the main memory. The microprocessor then executes the computer program instructions stored in the main memory to implement the software object.

Alternatively, other types of general purpose computers are used to host a business server. For example, the business server may be hosted by Personal Digital Assistants (PDAs) or computer systems dedicated to hosting Internet servers.

Referring again to FIG. 1, business host 1096 hosts business server 1015 and is operatively coupled to local area network 1080 via business communications link 1020. The business communications link is adapted to support various communications protocols based on the Transport Control Protocol/Internet Protocol (TCP/IP) such as Hyper Text Transfer Protocol (HTTP), Simple Mail Transfer Protocol (SMTP), and File Transfer Protocol (FTP) among others. The business server uses the software services and hardware links provided by the business host to communicate with other software objects across the local area network and the Internet. Database host 1076 hosts database server 1075 and is operatively coupled to the local area network via database link 1078. The database server provides access to Internet database 1010 and legacy database 1000. The business server stores and retrieves data from the Internet database and the legacy database using services provided by the database server. The legacy database contains data accessible in a format not normally suited for Internet applications. The business server provides services to Internet based clients to retrieve, manipulate, transmit, and store legacy data using the database server. Other databases accessible to the business server, such as the Internet database served by the database server, contain documents suitable for transfer over the Internet using one of the suite of Internet communications protocols such as HTTP or SMTP. The business server and the database server communicate to each other via the local area network.

Firewall host 1086 hosts firewall 1085. The firewall host is operatively coupled to the local area network via internal firewall communications link 1070. The internal firewall communications link is adapted to support various communications protocols based on TCP/IP such as HTTP, SMTP, and FTP, among others. The firewall host is operatively coupled to Internet 3 via external firewall communications link 1090. The external firewall communications link is adapted to support various communications protocols based on TCP/IP such as HTTP, SMTP, and FTP, among others. The Internet is commonly called the World Wide Web (Web) when software objects communicate to each other over the Internet using one of a suite of communications protocols based on TCP/IP such as HTTP. In alternative embodiments, the Internet may be replaced using any computer network system capable of supporting electronic document transfers such as a local area network or a virtual proprietary network.

The firewall filters incoming Internet data packets to ensure that only data packets for specified communications protocols are passed from the Internet to the local area network. The business server communicates with software objects over the Internet through the firewall using a variety of communications protocols for communication. Exemplary communications protocols are: HTTP used for the transfer of documents written in one of various mark up languages such as Hyper Text Markup Language (HTML) or XML; Simple Mail Transfer Protocol (SMTP) for the transfer of electronic mail (email) messages; and File Transfer Protocol (FTP) for the transfer of text and binary files.

An exemplary software object capable of sending messages to the business server via the Internet is exemplary partner server 1030. The partner server is hosted by partner host 1032 that is operatively coupled to the Internet via partner communications link 1025. The partner communications link is adapted to support various communications protocols based on TCP/IP such as HTTP, SMTP, and FTP, among others. In operation, the business server and the partner server request and send data to each other over the Internet. For example, the partner server may send an Internet document composed in XML to the business server. The content and structure of the XML document may be decomposed by the business server to create instructions for a purchase order. This purchase order may require the updating of the legacy database and retrieval of an Internet document from the Internet database. The retrieved Internet document is sent by the business server back to the partner server as an order acknowledgment. Any business transaction involving the transfer of data may be implemented so long as the business server and the partner server agree on the appropriate data structure and communications protocol.

Business server 1015 may also communicate over the Internet to other software objects. The business server may send email messages to email server 1045 hosted by email server host 1046 using SMTP as the communications protocol The email server host is operatively coupled to the Internet via email server communications link 1040. The email server communications link is adapted to support mail communications protocols based on TCP/IP such as SMTP and Post Office Protocol (POP). The email messages are held by the email server until they are retrieved by email client 1060 hosted by email client host 1062. The email client host is operatively coupled to the Internet via email client communications link 1065. The email client communications link is adapted to support various communications protocols based on TCP/IP such as POP. The business server uses email messages to send informational messages about the operations of the business server. For example, the business server may send an email message to the email server to acknowledge a purchase order or to alert a customer that a product is on back order.

The business server may also send Internet documents over the Internet in response to requests from exemplary Web client 1055 using HTTP as the communications protocol. The Web client is hosted by Web client host 1056. The Web client host is operatively coupled to the Internet via Web client communications link 1050. The Web client communications link is adapted to support various communications protocols based on TCP/IP such as HTTP. The Web client is used to obtain information from the business server. For example, the Web client may send a request to the business server for an HTML document containing a product catalog. The business server finds the HTML catalog document and forwards the HTML catalog document Web client. The Web client interprets the HTML catalog document to create a catalog display.

FIG. 1b is a simplified high level graphical representation of an exemplary set of interactions between multiple business systems in an exemplary e-commerce application.

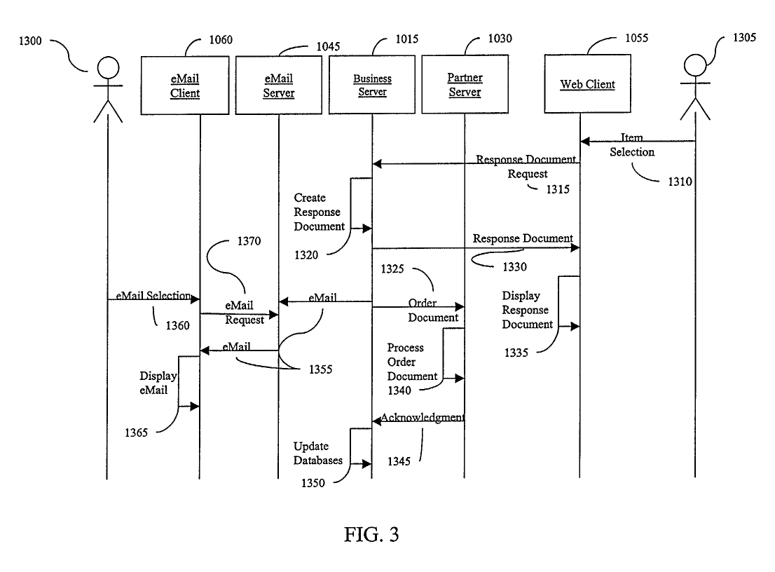

FIG. 3 is a sequence diagram illustrating an exemplary business transaction between a business server and a partner server. Customer 1305 uses Web client 1055 to send response document request 1315 to business server 1015. The body of the response document request contains item selection 1310 and instructions for purchase of the selected item from an online catalog. The requested response document is an acknowledgment of the item selection and purchase instructions. The business server receives the response document request and parses 1320 out the item selection and purchase instructions from the response document request and creates a response. As part of the parsing step, the business server queries legacy database 1000 (FIG. 1) for item availability and pricing and composes a response document based on templates stored in Internet database 1010 (FIG. 1). The business server sends response document 1310 to the Web client and the Web client interprets 1335 the response document to create a display.

The business server notifies a business partner that a purchase order has been processed for the selected item. The business server sends email message 1355 to email server 1045 as part of a business partner notification process. Business partner 1300 uses email client 1060 to make email selection 1360 that is sent as email request 1370 to the email server. The email server sends the email message to the email client and the email client displays 1365 the email message to the business partner.

The business server orders new items from partner server 1030. To do so, the business server sends order document 1325 to the partner server. The partner server processes 1340 the order document and sends acknowledgment 1345 to the business server. The business server uses data contained in the acknowledgment to update 1350 the legacy database.

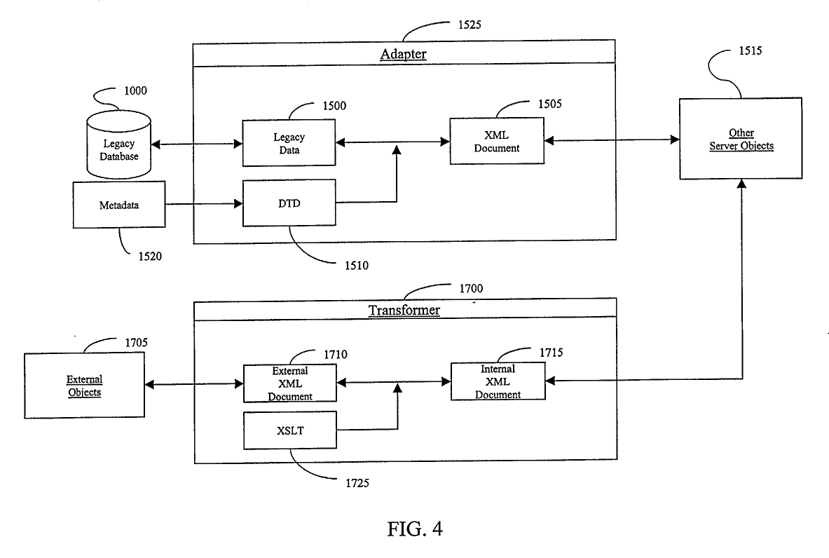

The business server translates data between legacy data systems and between disparate Internet data systems. FIG. 4 depicts data flow within two classes of software objects responsible for data translation operations within the business server. Adapter software object 1525 converts legacy data 1500 read from legacy database 1000 into XML document 1505 using the document description found in DTD 1510 for the XML document. The XML document is sent to other server objects 1515 for further processing. The adapter converts Internet documents into a format useful for updating the legacy database. The adapter object receives the XML document from another server object and converts the XML document into legacy data for storage in the legacy database. Alternatively, the adapter may create a DTD for the converted XML document when metadata is available for creation of the DTD. The adapter reads metadata 1520 and creates DTD 1510. The adapter uses the DTD to create the XML document from the legacy data read from the legacy database. Thus, the adapter uses the metadata to direct and control the translation of data between the legacy database and XML document data structures.

Transformer object 1700 translates one XML document into another XML document. The transformer receives external XML document 1710 from external object 1705. The XML document may need to be translated into internal XML document 1715 before it is passed to other server objects 1515. The translation from an external XML format to an internal XML format allows a single set of internal server objects to process a wide array of external XML documents regardless of their format or source. The single set of internal server objects need only know how to manipulate a set of internal XML documents so long as each type of external XML document format is translatable into one of the known internal XML document formats.

Translation may be accomplished if a translation document in the form of an Extensible Style Language Transformation (XSLT) document exists for each translation. An XSLT document specifies how one XML document may be translated into another XML document. The transformer reads in the external XML document and translates it using XSLT document document 1725 into the internal XML document. The internal XML document is then sent on to other server objects for use within the business server. The transformer may also handle translations from internal XML documents into external XML documents in an analogous manner. The transformer reads an internal XML document and uses a XSLT document document to translate the internal XML document into an external XML document.

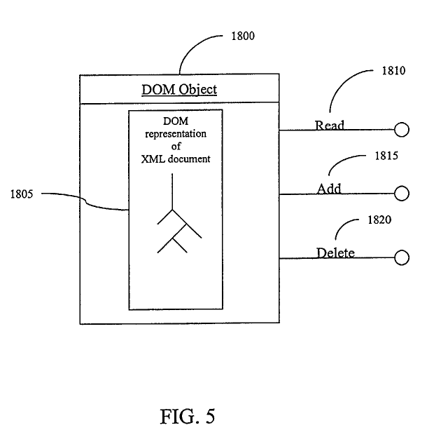

FIG. 5 is a depiction of a DOM object software object. The purpose of DOM object 1800 is to encapsulate a DOM representation of a XML document and expose a plurality of methods useful for manipulation of the DOM and consequently the XML document represented by the DOM. The DOM is contained within an internal data structure 1805. The internal data structure reflects the tree structure of the DOM and is in a suitable form where nodes and leaf elements may be added and deleted. The internal data structure is known as an infoset and embodies characteristics defined by the W3C Infoset working group. This information may be viewed at: http://www.w3.org/TR/xml-infoset. A plurality of methods for operation on the infoset are exposed for use by other software objects. Exemplary read 1810 method provides a way to populate the infoset by reading an XML document from a datastore. Exemplary add method 1815 provides a way to add new elements to the infoset. Exemplary delete method 1820 provides a way to delete elements from the infoset. Other software objects may invoke and modify a DOM object as a way of reading and modifying a XML document without knowing how each desired operation is actually performed on the XML document.

The path an incoming document takes through the business server is specified by documents containing instructions read by the objects comprising the business server. A personality document is used to link an incoming document to a business processes. Each business process is defined in a behavior document comprising a series of actions to apply to the incoming document.

The personality and behavior documents are composed in XML. In the case of a procedural language such as C, a function call with a void return value takes the form of ‘foo(bar1, “bar”);’; The ‘( )’, ‘,’, ‘“”’, and ‘;’ characters are syntactic elements that direct a compiler or interpreter to prepare a call to the function ‘foo’ passing in the variable ‘bar1’ and the value ‘bar’. In a similar manner, tags in an XML document are used as syntactic elements to specify instructions for directing operations within a business server. For example the following XML fragment can be used to specify a call to the function ‘foo’: <Foo variable=‘bar1’> bar </Foo>. The attribute ‘variable’ is used to specify the input parameter passed as a variable and the text node ‘bar’ is used to specify the parameter passed as a character string.

In another embodiment of the present invention, the personality and behavior documents are preprocessed, as in an interpreted language such as VB Script, into bytecode.

In another embodiment of the present invention, the personality and behavior documents are compiled directly into machine code.

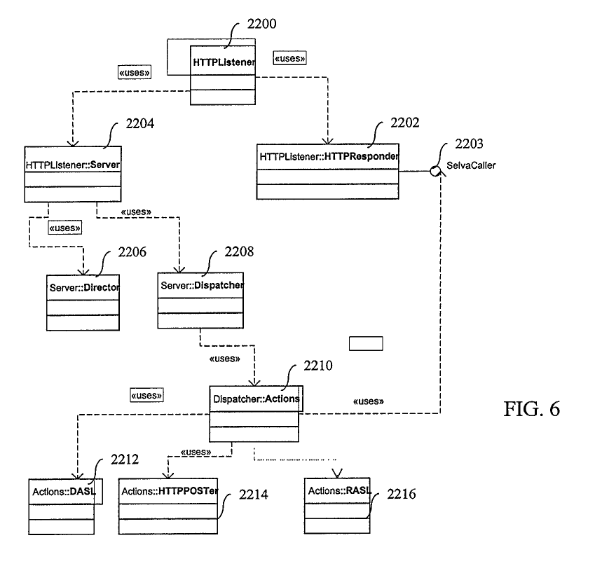

FIG. 6 is a class diagram of an embodiment of a business server according to the present invention. At the highest level, a listener 2200 is operably coupled to a server 2204. The listener receives messages from a client via a communications link. The listener passes the messages to the server via a callable interface in the server. The server then processes the messages.

When the listener is instantiated, it reads a configuration file. This is a file that contains information about what port to listen on, what level of diagnostics to use, where to write errors, how many threads to put in a thread pool, etc.

The listener is a multi-threaded server that launches a pool of threads, each of which instantiates a server object. When another 3^{rd} party server, such as Microsoft Internet Information Server or Apache, calls the server, the 3^{rd} party server takes on the responsibility of creating and managing threads.

The listener creates a server socket to listen on the indicated port, and the specified number of threads in the thread pool is started. Each thread instantiates a server object, initializes the server object, and waits for a message to come in on the server socket.

When a message is received by the listener, the listener parses the message. A responder object 2202 is created and initialized. The server call from the listener to the server includes a reference to a software object located on the client implementing an interface with an exposed method 2203 used when a response or post is sent to the client. The client's implementation of the interface includes socket connections and whatever state information is required to send the response or post to the client. The received message is sent to a transaction method of the server object along with a reference to the responder object.

At the end of message processing, the server object will call the exposed method of the responder object, and the responder object will send a response to the client and complete the socket connection. The server object will return to the listener thread, that will go back to waiting for the next message.

In another embodiment, the exposed method is used to post information and request a response from the client.

The server processes the message by routing the message through a director 2206 and through a dispatcher 2208 before control is returned to the listener.

The director inspects business document elements in the to-be-described server personality document. If the business document element is of type “XML” and there is no criteria element, then the business document element's behavior attribute is used to find and load a behavior for the server to process the received message.

If there is a criteria, the criteria is evaluated, and if it returns True, this is the right business document element and the business document's behavior attribute is used to find and load a behavior for the server to process the received message.

If the business document element is of type “Java”, then an object ID attribute is used to instantiate a software object implementing a server director test method. The received message is passed to a isMyType( ) method in the software object. If this method returns True, then this is the right business document element and the business document's behavior attribute is used to find and load the behavior.

If all business document objects are exhausted, and none passed, then an exception is thrown.

When the dispatcher is called, one of two conditions exists: either a new transaction has been loaded and a behavior file with no current action attribute is in working memory; or a resumed transaction with a current action attribute is in a working memory.

If no current action attribute exists, a current action attribute is created and a first level of actions is called. If one of the actions encountered is of a new behavior and there is no behavior element under this action the new behavior is loaded and grafted under the action element, and this behavior is processed recursively.

If one of the actions encountered is of a new behavior and there is a behavior element grafted under the action element, the previously grafted behavior is processed before the new behavior is processed.

If one of the actions is a suspend action, then the current behavior's current action is incremented and action within the behavior is suspended. All working memory objects are stored in a single previously described DOM object. The DOM object is stored in a repository such as a database or directory. A suspend exception is thrown to bypass further processing and control returns to the server object.

When all processing for a behavior is finished, control is returned to the previous behavior's next action.

When all processing for the top level behavior is completed, the transaction is finished and control is returned to the server object, which passes control back to the listener or whoever the caller was.

Actions initiated by the dispatcher include behaviors performed by a Database Access Server Language (DASL) document parser 2212. A DASL document specifies a set of database access rules for accessing a local resource such as a locally hosted database server (not shown). A Remote Access Server Language (RASL) document parser 2216 provides remote resource access in much the same way as the DASL document parser by parsing a document specifying remote database access operations.

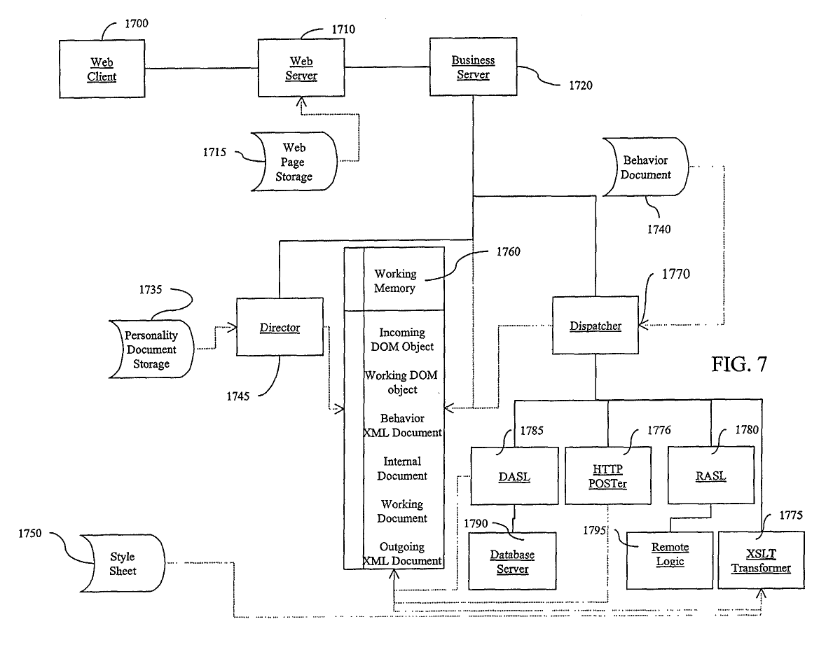

FIG. 7 is a cooperation diagram depicting the operations in an embodiment of a business server during an exemplary business transaction. A Web client 1700 posts an incoming document to a Web server 1710. The document is written in a markup language and contains at least one XML fragment specifying a business transaction. The post from the Web client specifies a Web page 1715 to be read by the Web server from a Web page storage. The Web page contains instructions to remove the XML fragment from the incoming document to create an incoming XML document. The Web server sends the incoming XML document to a business server 1720. The business server invokes a director 1725, passing in the incoming XML document. The director creates incoming DOM object 1730 encapsulating the incoming XML document. The director stores the incoming DOM object in a working memory 1760. This creates an incoming document in the working memory that can be accessed by disparate objects invoked to process the incoming document.

The director reads in a personality document 1735. The personality document defines business operations to be implemented by the director in the form of behaviors. The director tests the incoming DOM object to determine which behavior documents need to be read to process the incoming document. If a behavior is identified, the director reads in a behavior document 1740 and stores the behavior document in the working memory.

The director returns control to the server.

The server invokes a dispatcher 1770 to perform the behaviors identified by the director. The dispatcher invokes a transformer 1775 passing in a name for a translation document 1750. The incoming transformer uses the translation document to translate the incoming document encapsulated in the incoming DOM object into an internal document processed by other objects as specified by the behavior document chosen by the director. The transformer stores the internal document in the working memory.

The director invokes a dispatcher 1770 to process the internal document created by the incoming transformer using the business process specified by the behavior document chosen by the director. The dispatcher reads the behavior document and parses the behavior document initiating the business processes specified within the behavior document.

A behavior document specifies many different possible actions. Each of these actions can be specified by a document. An example action is validation of an incoming document against a DTD for that document. Another possible action is the accessing of data from a local database using according to a DASL document. To access a local database server 1790, the dispatcher invokes a DASL parser 1785. The DASL parser in turn uses the services of database server 1790 to read data from a legacy database and populate a working document stored in the working memory.

To access a remote resource 1795, the dispatcher invokes a RASL parser 1780. The RASL parser in turn uses the services of database server 1790 to read data from the remote resource and populate a working document stored in the working memory.

Once processing is finished, the dispatcher invokes transformer 1775 passing in a name for an XSLT document specifying the conversion of the working document into an outgoing document. The transformer reads an outgoing document and creates an outgoing document from the working document. The outgoing document is made available to other objects by placing the outgoing document in the working memory. The dispatcher then invokes HTTP POSTer 1776 to send the translated outgoing document back to the Web client.

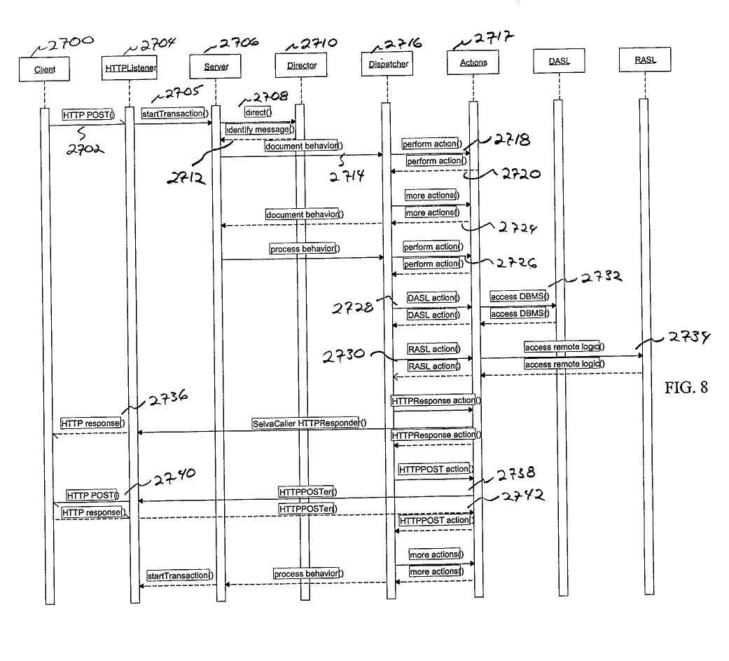

FIG. 8 is a sequence diagram of an embodiment of a business server business transaction according to the present invention. A client 2700 sends a HTTP POST message 2702 to a HTTP Listener 2704 hosted by a business host. The HTTP POST message includes an markup language fragment describing an incoming document. The incoming document includes a proposed business transaction such as a purchase order.

The HTTP Listener receives the HTTP POST and sends a start transaction message 2705 to an instance of a server 2706. The start transaction message includes the incoming document received by the HTTP listener. The server forwards the incoming document 2708 in a director message to a director 2710. The director uses a personality document to identify the message and determine what behaviors should be invoked to complete the business transaction as proposed within the incoming document. If the director identifies the incoming document as document that the server knows how to process, the director sends an identification message 2712 to the server.

If the director identifies the incoming document, the server invokes a dispatcher object 2716 with a document behavior message 2714. The dispatcher uses the incoming document and the identified document behaviors to perform one or more actions 2717 such as document processing actions 2720 and 2724, on the incoming document. An exemplary document processing action is translating the incoming document into a working document stored within the working memory as previously described.

Once translated and stored in working memory, additional business processing actions 2726, 2728, and 2730 are performed using the working document and its identified behaviors.

An exemplary business processing action is accessing a local database according to a DASL document. If a DASL action is called for by a DASL action in a behavior file, an access database message 2732 is sent to a DASL parser 2733 and the DASL parser parses a DASL file in order to complete the database access action.

Another exemplary business processing action is accessing a remote resource according to a RASL document. If a RASL action is called for by a RASL action in a behavior file, an access remote resource message 2734 is sent to a RASL 2736 parser and the RASL parser parses a RASL file in order to complete the remote resource access specified in the action.

At the end of the incoming document processing, a response is sent via an HTTP responder (not shown) back to the client.

In another embodiment of a business transaction, a POST message 2738 and 2740 is sent from the server to the client using the client's previously described exposed POST method. The server waits to receive a response 2742 from the client before other actions are processed.

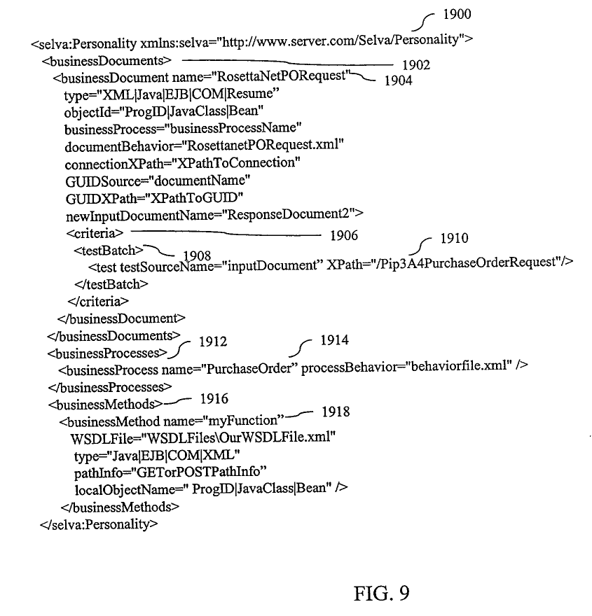

As previously noted, the operations of the business server are fully specified by a series of interrelated documents written in a document markup language such as XML. The operations of the director are controlled by a personality document. FIG. 9 is an embodiment of a personality document according to the present invention. Title tag 1900 identifies the document as a personality document.

A business document container 1902 includes all business document descriptions. The exemplary business document description is responsible for dealing with documents sent to the server and document-based messaging.

A business document element 1904 includes a business document description. There are one or more business document elements in a personality document. Business document elements identify a business document that has been received, identify how to transform the business document (i.e. which document business process in the form of a behavior to apply to the business document), and where to send the business document for processing (i.e. which process behavior to apply to the business document).

A “name” attribute defines a name for referring to the business process that is used to handle this particular type of document.

A “type” attribute specifies the type of behavior. The default value for this is “XML”.

An “objectid” attribute is either a ProgID for a COM object, or a Java class name, or a bean name to be called. The relevant programming has a method with the definition:

Boolean IsMyType(String InputDocumentXML)

The method returns True to indicate that this document is indeed one that must be processed. The object also includes a method that returns the XML document for the working document:

String Convert (String InputDocumentXML)

A “businessProcess” attribute defines the name of the business process that implements the functionality to handle the incoming document.

A “documentBehavior” attribute defines the path to a behavior file that describes how to process the received document in preparation for the business process. A behavior file includes three parts: an optional validation; a transformation to the working document format; and a call to the process behavior. Alternatively, the “documentBehavior” attribute can be the special string “*Resume”, in which case an existing but suspended business transaction is resumed.

The following attributes are used for the case where the “documentBehavior” attribute value is “*Resume”. A “connectionXPath” attribute defines the XPath to a connection (in the connections section of the Identity file) used to save or retrieve a suspended transaction. A “GUIDSource” attribute defines the name of the working document from which to get the GUID. A “GUIDXPath” attribute defines an XPath (in the InputDocument) of the location that contains a GUID for reconstituting the suspended transaction. A “newInputDocumentName” attribute defines a name for the new input document. When a transaction was suspended, it had it's own “InputDocument” in the Working Memory. The new transaction also has an “InputDocument”, so this attribute is used to rename the current “InputDocument”, so that the reconstituted document can still have it's original “InputDocument” value.

A business processes tag 1912 is a container for a list of business processes that revolve around a line-of-business (LOB) system, like a “Price Check” or “Inventory Request” or “Purchase Order Request”.

A business process tag 1914 represents a business process that revolves around a LOB system. A “name” attribute defines a name for the business process.

A “processBehavior” attribute defines a to be described behavior file that defines how to work with the canonical form of the document.

A business methods tag 1916 serves as container element for a section of the personality document that deals with method calls to a business server using Simple Object Access Protocol (SOAP).

A business method tag 1918 serves as a container element for a specific test for a business method that will handle an incoming request. This section is processed somewhat differently than the business document sections, in that the real identifier is the name attribute. These are used for both providing metadata to clients that request it and for handling requests from clients.

A “name” attribute uniquely identifies a business method from any other business method in the Personality file and it is the name of the business method (a.k.a. Web Service, a.k.a. SOAP Method) that the business server will now provide

A “pathinfo” attribute is used to match against the POSTed path information received from a client.

A “WSDLFile” attributed defines a path to a Web Services Description Language (WSDL) XML file. This file is used to provide metadata to a calling application.

A “type” attribute defines a type of an internal implementation.

A “localobjectName” attribute defines a ProgID, Java class name, or bean to be called to process an incoming message. This is irrelevant if the type attribute has the value ‘XML’.

A “translator” attribute defines an XSLT document used to translate the incoming SOAP message into a working document in a working memory, and would be used if the type attribute had the value “XML”.

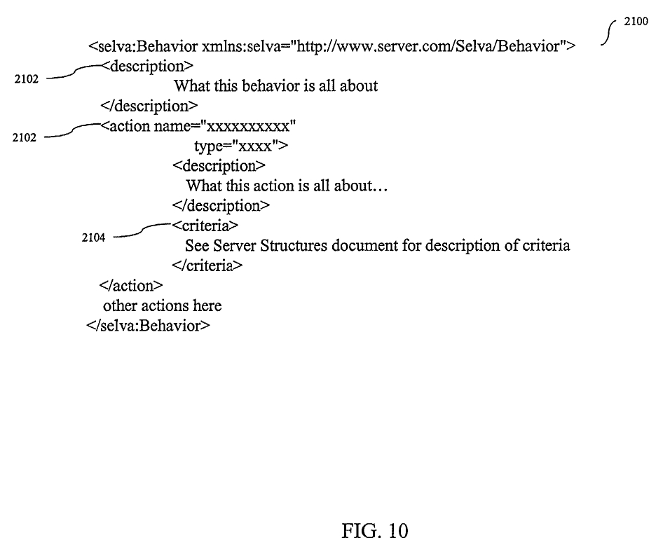

FIG. 10 is an embodiment of a behavior document according to the present invention. A behavior tag 2100 identifies the document as a behavior document. A description tag 2102 defines a description of the behavior documents purpose and inner workings.

An action tag 2102 specifies what action should be performed on an incoming document or a working document stored in a working memory. Actions are used to determine specific steps within a workflow.

A “name” attribute defines an action name for an action and serves to identify a particular action to distinguish the particular action from all other actions. The action name is unique within a behavior.

A “type” attribute defines an action type for the action. Many actions are possible. APPENDIX A contains a list and description of actions implemented within an embodiment of a business server according to the present invention.

A “description” attribute defines an action description describing what the action does.

A criteria tag 2104 describes a previously described optional criteria child element. If the action does not contain a criteria, the action is unconditionally performed. If the action does contain a criteria child element, then the criteria child element is processed to determine if the action is to “fire” or is to be skipped.

At runtime, several attributes are appended to the behavior document. A “GUID” attribute defines a unique identifier for the transaction. The unique identifier is used to save or restore a suspended transaction, or other situations where a uniquely identified transaction is desired.

A “transactionStartTime” attribute holds a transaction start time, in ISO date format. E.g.: yyyy-mm-dd hh:mm:ss.

A “transactionStartTimeMS” attribute holds a transaction start time, in milliseconds.

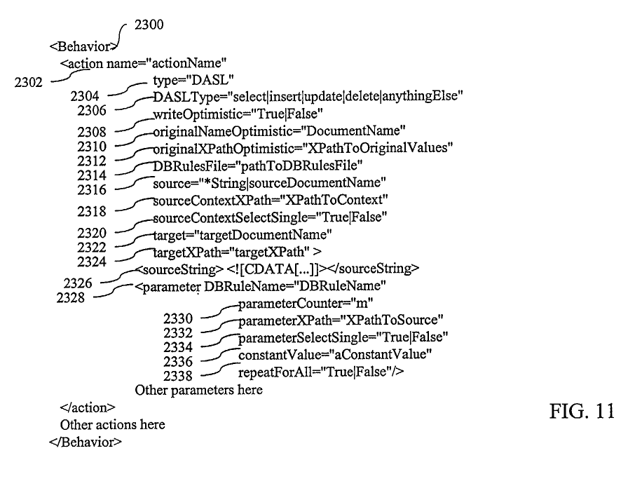

FIG. 11 is an example DASL action definition. A behavior tag 2300 identifies the document element for the behavior. An action tag 2302 marks the definition of attributes defining various processes to be performed by the server.

The action name attribute 2303 defines the name of the action. It is used in error messages, exceptions, tracing or logging.

The type attribute 2304 identifies the type of action being taken. In this case it is of type “DASL”.

The DASL type attribute 2304 defines the type of the DASL action. If this is an empty string, all database rule elements in a database rules file will be fired. Otherwise, only those database rule elements with a type attribute that matches this value will be fired.

A write optimistic attribute 2308 is used to indicate that an optimistic write is to be performed.

An original name optimistic attribute 2310 contains a name of a document containing the original values for optimistic locking.

An original XPath optimistic attribute 2312 contains a XPath to the node that is the parent of original values, for optimistic locking purposes. If this attribute contains an empty string, then the original name optimistic attribute value points to an entire document that is the original value.

A database rules file attribute 2314 contains a relative path and filename of the database rules document.

A source attribute 2316 contains the name of a source document.

A source context XPath attribute 2318 defines a node list of nodes in a source document that will be used for the context of subsequent operations.

A source context select single attribute 2320 is a flag used to indicate whether only the first node of the node list generated above will be used. Default value, if omitted is False.

A target attribute 2322 is the name of a previously described target document.

A target XPath attribute 2324 contains the name of a location in the target document to put the result tree(s) of the database rules processing.

If a source string attribute 2326 is “*String”, it is a literal document, stored as text or as a CDATA section, to be used.

A parameter attribute 2328 is an element that defines the value(s) to be used for fulfilling parameter markers in a command. A “DBRuleName” parameter defines a name of the database rule element in the database rule document that this parameter is fulfilling.

A counter parameter 2330 defines the number for the above referenced DBRule element that is being fulfilled.

A XPath parameter 2332 defines an XPath, relative to the current context node, of the data value(s) to fulfill the parameters.

A select single parameter 2334 indicates that only the first node from the node list returned by the XPath parameter value is to be used. Otherwise, additional values are passed to repeated invocations of the prepared command.

A constant value parameter 2336 replaces the XPath parameter and select single values to indicate a constant to be used instead.

A repeat for all parameter 2338 if present indicates whether a returned value is to be repeated for all invocations of the command. This allows repeatable header information to be used in detail line invocations.

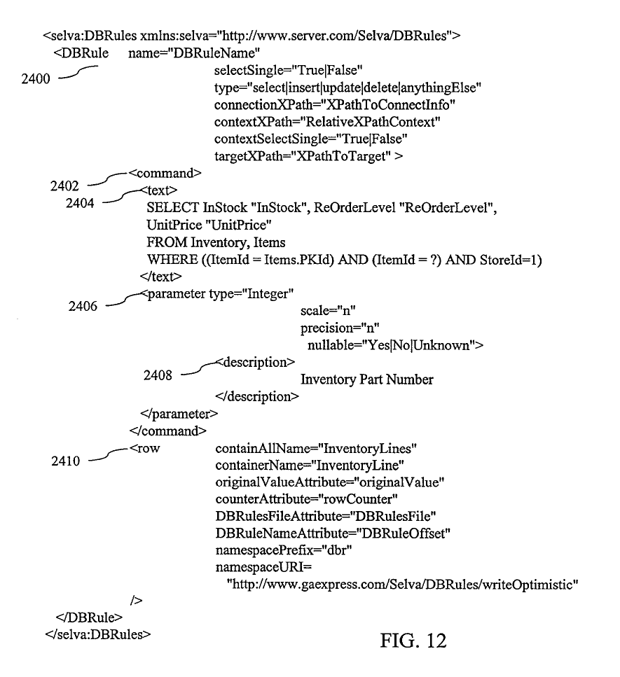

FIG. 12 is an embodiment of a database rules document according to the present invention.

A database rule tag 2400 is a container for each command sent to a database system. There can be one or more of these in each database rules file.

The “name” attribute is the name of the data base rule and is referenced in a database rule name attribute 2328 (FIG. 9) of the parameter element in an action in the previously described DASL behavior file.

A “selectsingle” attribute indicates whether a context XPath 2318 (FIG. 9) passed in from an action returns a node-list or a single node (first in the node-list). This attribute is optional, and defaults to false, if omitted and if not specified in the action. It can be omitted and the action can specify a value for this instead, in which case the action's value is used. If the action and the database rule both specify this setting then if one of them is true then the effective resulting value is true.

A “type” attribute allows the specification of which database rules to apply in a document when called from an action. The action passes in a DASL type value 2304 (FIG. 9) which is either an empty string or null, in which case all database rules get applied, or a string, in which case only matching database rules get applied. It is an error to pass in a string and not match any database rules type attributes.

A “connectionXPath” attribute allows the specification within a personality file, the XPath to the connection that specifies the connection type (JDBC, ODBC, ADO), and the connection string or JDBC URL for the connection.

A “contextXPath” attribute specifies an XPath, relative to a DASL context, at which to process the database rule. This is optional. If omitted, the XPath from the DASL action is applied.

A “contextSelectSingle” attribute is a Boolean flag that indicates whether the “contextXPath” attribute is to return the first node or all nodes. This is optional, if omitted, the setting from a DASL action is applied.

A “targetXPath” attribute defines a relative target XPath (optional) for an output. It is applied after using the DASL target XPath value 2324 (FIG. 9).

The command tag 2402 is a container for the command that is issued to the back-end database system for processing. This command can contain parameter markers. The command is issued with a prepare, in order to determine the number and type of parameters that must be fed into the statement. In this embodiment, a text string 2404 comprising a database query is issued as the command.

A parameter tag 2406 is used to define metadata for each parameter.

A “selectsingle” attribute defines whether an XPath used to feed the parameter can result in multiple calls into this statement or if just the first node in the node-list returned by the XPath is to be used for feeding this statement. This is an optional value, which if omitted defaults to False. An action can specify this for any parameter, in which case the action's value is used if this value is missing. If both the action and this attribute are specified, this attribute overrides the action's attribute for this parameter.

A “type” attribute indicates the data type of the parameter.

A “scale” attribute defines a number of decimal places in a numeric value.

A “precision” attribute defines either the number of significant decimal positions, or the maximum length for length-constrained text values.

A “nullable” attribute indicates whether the field is nullable or not. This attribute has three possible values, “Yes” it's nullable, “No” it's not, “Unknown” which generally means “be ready to receive a null but don't send one”.

A description tag 2408 contains an element describing the database rule.

A row tag 2410 is an optional element which is used to indicate how to put a container element around rows of generated output, what to call these containers, and some attributes that can be put in to uniquely identify where rows came from. This is NOT optional, if the write optimistic attribute 2308 (FIG. 9) is True, as these values are used at write and delete time.

A “containAllName” attribute defines the name of a container for all rows. If omitted, no container is created.

A “containerName” attribute defines the name of the container element to put around the row of output. All other values are dependent on this value being present, as they indicate attributes of this element.

An “originalValueAttribute” attribute is the name of an attribute used to hold an original value. The default value used by the database rule is “originalvalue”

A “counterAttribute” attribute if present, gives a name of an attribute to be added to a row container element. The default value is the “rowCounter” attribute.

A “DBRulesFileAttribute” attribute defines the name of an attribute to be added that has the path and filename of the database rules document that generated this output row. The default value is the “DBRulesFile” attribute.

A “DBRuleNameAttribute” attribute defines the name of an attribute to be added that contains the name of the database rule element within the database rules file that generated this output row. A default value for the “DBRuleNameAttribute” attribute is “DBRuleOffset”.

A “namespacePrefix” attribute defines a prefix used for the above attribute names when they are appended to the row container element. A eefault value is “dbr”.

A “namespaceURI” attribute specifies the URI used in the namespace declaration.

When a DASL action is encountered in a server behavior file, the server passes the action node and the previously described working memory to a DASL processor. The DASL processor performs its actions against references to objects contained in the working memory.

In one embodiment of a DASL processor, used in a Windows environment, the working memory is implemented as a dictionary.

In another embodiment of a DASL processor, used in a Java environment, the working memory it is implemented as a Java hash table.

When DASL document is parsed the following processing takes place. A collection of database rule elements is created, with the appropriate type attribute as specified in the “DASLType” attribute of the action node. For each database rule in the collection the appropriate connection is retrieved or created and the context node list is retrieved. If the select single attribute is set to true, then only one node is returned in the list.

For each node in the node-list, the parameters from the action node are processed, returning node-lists. If the “selectSingle” attribute is set on these, then only the first node from the node-list is processed. An array of “rows” of parameters is built from these node-lists.

For each “row” of parameters, a statement is prepared and the row of parameters is passed in, converted as necessary for the appropriate data type. The defined statement is executed with these parameters.

A tabular output tree is built and put it in the specified output document or location of an output document in the working memory.

Finally, database system connections are released to a pool of connections.

Referring again to FIG. 8, a dispatcher object 2210 can also invoke an object to interpret a document written in Remote Access Server Language (RASL). RASL is used to compose documents for accessing services outside of the local system such as remote databases or other business servers.

A RASL interpreter comprises a Simple Object Access Protocol (SOAP) listener operably coupled to a Java object.

The SOAP listener exposes methods to allow discovery and saving of both Web Services Description Language (WSDL) files and a mapping layer. The SOAP listener accepts SOAP calls, uses the mapping layer to convert the SOAP calls to actual method calls, and uses the mapping layer to convert output to SOAP responses.

The Java class implements a RASL document by combining parameters from an action node with a Remote Process Call (RPC) rules document to implement calls to a SOAP server and a RPC rules files that define a SOAP service that can be called by a business server.

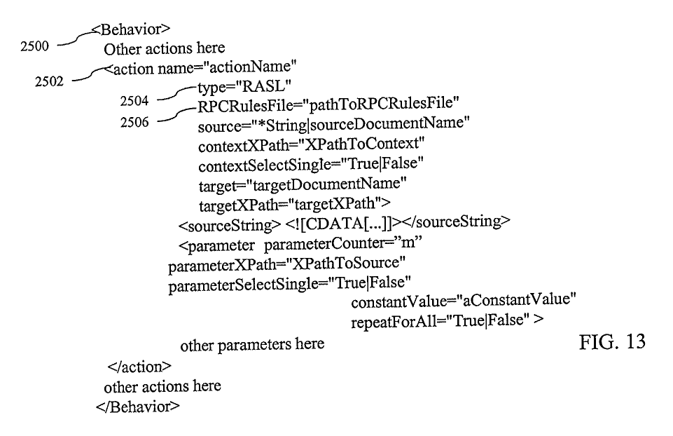

FIG. 13 is an embodiment of a RASL action for a server behavior document. A RASL action is similar to the previously DASL action and only the differences will be discussed.

A behavior tag 2502 identifies the document element for the behavior. An action tag 2502 marks the definition of attributes defining various processes to be performed by the server.

A type attribute 2504 defines the action as a RASL action.

A RPC rules file attribute 2506 defines a relative path and filename of the RPC rules document.

A “source” attribute defines a name of a source document in the previously described working memory.

A “contextXPath” attribute defines a node list of nodes used for the context of subsequent operations.

A “contextSelectSingle” attribute defines a flag used to indicate whether only the first node of the node list generated above will be used. Default value, if omitted is False. If multiple contexts are generated, then each one will generate a “call” to the method, and the output values will be treated as “rows” of data.

A “target” attribute defines a name for a target document.

A “targetXPath” attribute defines a location in the target document to put the result tree of the RPC rules document processing.

If a “sourceString” attribute is “*String”, this is a literal document, stored as text or as a CDATA section, to be used.

A “parameter” attribute defines values used for fulfilling parameter markers in a command.

A “parameterXPath” attribute defines an XPath, relative to the current context node, of the data value(s) to fulfill the parameters.

A “parameterSelectSingle” attribute defines if a first node from the node list returned by the parameter XPath value (above) is to be used. Otherwise, additional values are passed to repeated invocations of the remote method.

A “constantValue” attribute defines a constant replacing the “parameterXPath” and “parameterSelectSingle” attribute values to indicate a constant is to be used.

If the “repeatForAll” attribute is present, the value returned is to be repeated for all invocations of the command. This allows repeatable header information to be used in detail line invocations.

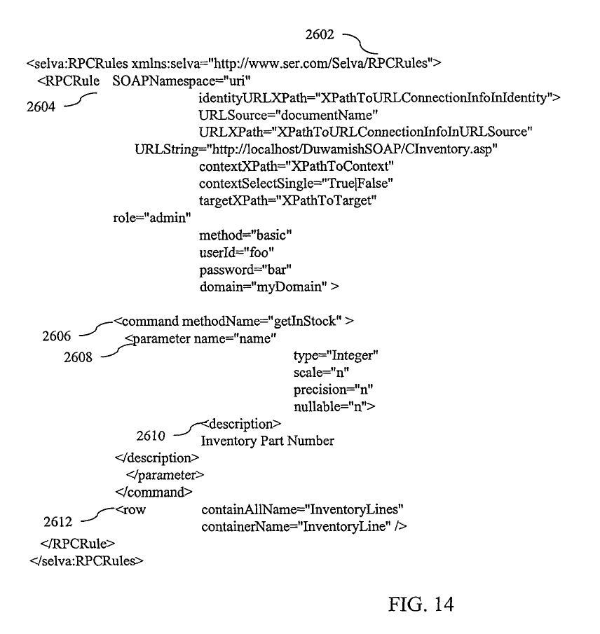

FIG. 14 is an embodiment of a RPC rules document according to the present invention. A RPC rule tag 2604 is the container for each command sent to a SOAP server. There can be one or more of these containers in each RPC rules document.

A “SOAPNamespace” attribute defines a namespace URI for the version of SOAP being used to call out.

An “IdentityURLXPath” attribute specifies a XPath within the Identity document to the URL that specifies the SOAP server.

A “URLSource” attribute specifies a source document that contains information on the URL to post to.

A “URLXPath” attribute specifies a XPath (in the document defined by the “URLSource” attribute) to an attribute or element containing a URL to post to.

A “URLString” attribute specifies an optional string value of the URL to post to. This overrides all of the above URL settings.

A “contextXPath” attribute specifies a XPath to a context node(s) in the source document. This will be applied after the value of RASL action's (FIG. 11) “contextXPath” attribute value is applied.

A “contextSelectSingle” attribute indicates whether a context XPath passed in from the action returns a node-list or a single node (just the first node in the node-list). This attribute is optional, and defaults to False, if omitted, and if not specified in a action. The action can specify a value for this, in which case the action's value is used. If the action and this setting are both specified, the setting here overrides the action.

A “targetXPath” attribute defines a single node, which is the target of the output of this command.

A “role” attribute defines a name of an authentication role looked up in the Identity document There are four methods to get the authentication information:

1. The “identityURLXPath” attribute is used to return a URL element from the Identity document. That URL element may contain a role attribute. That role attribute is used to return a single authentication element from the Identity document. That authentication element contains the values used to authenticate the SOAP request.

2. Alternatively, the “identityURLXPath” attribute is used to return a URL element from the Identity document and that element may explicitly contain attributes that contain the values used to authenticate the SOAP request.

3. The role attribute being described in this section is used to return an authentication element from within the authentications element in the Identity document. That authentication element contains the values used to authenticate the SOAP request.

4. This action can explicitly specify the ‘method’, ‘userid’, ‘password’ and ‘domain’ values as indicated below, and these are used to authenticate the SOAP request.

The explicit ‘method’, ‘userid’, ‘password’ and ‘domain’ values in a RPC rule always override any other way of obtaining them if they are present (method 4)

Explicit values obtained via the role attribute in the RPC rule take next precedence (method 3)

Next in line, are explicit values in the URL element returned by the “identityURLXPath”. (method 2)

Last in line are values obtained from the role attribute in the URL element returned by the “identityURLXPath” (method 1)

A command tag 2606 is the container for a method to be called by a back-end server system for processing. A “methodName” attribute defines the name of the SOAP method to be called.

A parameter tag 2608 is the container for defining metadata for each input or output parameter.

A “name” attribute defines the name of a parameter and will be supplied to a SOAP method along with the parameter's value.

A “type” attribute indicates the datatype of the parameter. The values used here are those that are defined in the W3C XSD recommendation.

A “scale” attribute defines a number of decimal places for certain numeric types, .

A “precision” attribute is used for either a number of significant decimal positions, or a maximum length for length-constrained text values.

A “nullable” attribute indicates whether a field is nullable or not. This attribute has three possible values, “Yes” it's nullable, “No” it's not, “Unknown” which generally means be ready to receive a null but don't send one.

A description tag 2610 is an element containing a description that can be put in to make it easier for a developer to know what the parameter is about.

A row tag 2612 is an optional element used to indicate how to put a container element around rows of generated output, what to call these containers, and some attributes that can be put in to uniquely identify where rows came from. In this case, an out parameter that returns an array is thought of as having as many rows as the largest array has elements.

A “containAllName” attribute defines a name of a container element to hold all ‘rows’ of output. If the sourceXPaths result in multiple calls to the method, each set of return values is treated as a ‘row’.

A “containerName” attribute defines a name of a container element to put around a ‘row’ of output. All other values are dependent on this value being present, as they indicate attributes of this element.

When a RASL action is encountered, a server passes the action node and the Working Memory to a RASL processor. The RASL processor performs its actions against references to objects contained in the previously described working memory.

A collection of RPC rule elements is created, with the appropriate type attribute as specified in the “RASLType” attribute of the action node.

For each RPCRule in the collection, the appropriate URL and context node list is retrieved. If the SelectSingle attribute is set to True, then only one node is returned in the list.

For each node in the node-list, the parameters from the action node are processed, returning node-lists. If the “selectSingle” attribute is set on these, then only the first node from the node-list is processed. An array of “rows” of parameters is built from these node-lists.

For each “row” of parameters, the command is called, passing in the row of parameters, converting the parameters as necessary for the appropriate data types. A tabular output tree is built and put it in the specified output document or location of an output document in the working memory.

A dispenser Java program exposes a set of core web methods which allow a remote client to ask about possible publishable services, and then POST back information, allowing the writing of both a WSDL and a mapping layer that defines how to map the exposed methods and parameters to an actual function and it's parameters.

Although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by claims supported by this application and the claim's equivalents rather than the foregoing description.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for processing a document, comprising:
providing at least one behavior document including processing instructions;
accepting an incoming document;
reading a personality document, the personality document including behavior document selection instructions for selecting a behavior document based on the incoming document;
selecting a behavior document using the personality document behavior document selection instructions and the incoming document; and
processing the incoming document according to the processing instructions in the selected behavior document.

2. The method of claim 1 wherein:
the personality document is a XML document; and
the selected behavior document is a XML document.

3. The method of claim 1, wherein the selected behavior document processing instructions further include incoming document to working document translation instructions.

4. The method of claim 3, wherein the selected behavior document processing instructions further include:
working document to outgoing document translation instructions; and
transmitting instructions for transmitting the outgoing document via a communication network.

5. The method of claim 1, further comprising transforming the incoming document into an incoming software object.

6. The method of claim 5, wherein the selected behavior document processing instructions further include invoking a document processing software object.

7. A method for processing a document received from a client via a communication network, comprising:
providing at least one behavior document including processing instructions;
providing at least one translation document;
receiving an incoming document from the client via the communication network;
reading a personality document, the personality document including:
behavior document selection instructions for selecting a behavior document based on the incoming document; and
translation document selection instructions for selecting a translation document based on the incoming document;
selecting a translation document using the personality document translation document selection instructions and the incoming document;
translating the incoming document into a working document using the selected translation document;
selecting a behavior document using the personality document behavior document selection instructions and the incoming document; and
processing the working document according to the processing instructions in the selected behavior document.

8. The method of claim 7, wherein the selected behavior document processing instructions further include transmitting instructions for transmitting the working document via the communication network.

9. The method of claim 7, wherein the selected behavior document processing instructions further include:
working document to outgoing document translation instructions; and
transmitting instructions for transmitting the outgoing document via the communication network.

10. The method of claim 7, further comprising transforming the working document into a working software object.

11. The method of claim 7, further comprising transforming the incoming document into an incoming software object.

12. The method of claim 7, wherein the selected behavior document processing instructions further include invoking a document parser.

13. The method of claim 7 wherein:
the serving document is a XML document; and
the selected behavior document is a XML document.

14. The method of claim 7 wherein:
the incoming document is a XML document;
the working document is a XML document; and
the selected translation document is a XSLT document.

15. A data processing system adapted to process documents received from a client via a communication network, comprising:
a processor; and
a memory operably coupled to the processor and having program instructions stored therein, the processor being operable to execute the program instructions, the program instructions including:
personality instructions, the personality instructions including:
receiving an incoming document sent by the client via the communications network;
invoking a director, the director containing instructions, the instructions including selecting processing instructions for the incoming document; and
invoking a dispatcher, the dispatcher containing instructions, the instructions including processing the incoming document according to the selected processing instructions.

16. The data processing system of claim 15, the processing instructions further including transmitting a document to the client via the communication network.

17. The data processing system of claim 16, the processing instructions further including transmitting a document to a server via the communication network.

18. A data processing system adapted to process a document, comprising:
a processor; and
a memory operably coupled to the processor and having program instructions stored therein, the processor being operable to execute the program instructions, the program instructions including:
accepting an incoming document;
reading a personality document, the personality document including behavior document selection instructions for selecting a behavior document based on the incoming document, the behavior document including processing instructions;
selecting a behavior document using the personality document behavior document selection instructions and the incoming document; and
processing the incoming document according to the processing instructions in the selected behavior document.

19. The data processing system of claim 18 wherein:
the personality document is a XML document; and
the selected behavior document is a XML document.

20. The data processing system of claim 18, wherein the selected behavior document processing instructions further include incoming document to working document translation instructions.

21. The data processing system of claim 18, wherein the selected behavior document processing instructions further include:
working document to outgoing document translation instructions; and
transmitting instructions for transmitting the outgoing document via a communication network.

22. The data processing system of claim 18, the program instructions further including transforming the incoming document into an incoming software object.

23. The data processing system of claim 18, wherein the selected behavior document processing instructions further include invoking a document parser.

24. A data processing system adapted to process a document sent from a client via a communication network, comprising:
a processor; and
a memory operably coupled to the processor and having program instructions stored therein, the processor being operable to execute the program instructions, the program instructions including:
receiving an incoming document sent by the client via the communication network;
reading a personality document, the personality document including:
behavior document selection instructions for selecting a behavior document based on the incoming document, the behavior document including processing instructions; and
translation document selection instructions for selecting a translation document based on the incoming document;
selecting a translation document using the personality document translation document selection instructions and the incoming document;
translating the incoming document into a working document using the selected translation document;
selecting a behavior document using the personality document behavior document selection instructions and the incoming document; and
processing the working document according to the processing instructions in the selected behavior document.

25. The data processing system of claim 24, wherein the selected behavior document processing instructions further include transmitting instructions for transmitting the working document via the communication network.

26. The data processing system of claim 24, wherein the selected behavior document processing instructions further include:
working document to outgoing document translation instructions; and
transmitting instructions for transmitting the outgoing document via the communication network.

27. The data processing system of claim 24, the program instructions further comprising transforming the working document into a working software object.

28. The data processing system of claim 24, the program instructions further comprising transforming the incoming document into an incoming software object.

29. The data processing system of claim 24, wherein the selected behavior document processing instructions further include invoking a document parser.

30. The data processing system of claim 24 wherein:
the serving document is a XML document; and
the selected behavior document is a XML document.

31. The data processing system of claim 24 wherein:
the incoming document is a XML document;
the working document is a XML document; and
the selected translation document is a XSLT document.

32. A computer program product embodying computer program instructions for execution by a computer, the computer program instructions comprising:
personality instructions, the personality instructions including:
receiving an incoming document sent by the client via the communications network;
invoking a director, the director containing instructions including selecting processing instructions for the incoming document; and
invoking a dispatcher, the dispatcher containing instructions including processing the incoming document according to the selected processing instructions.

33. The computer program product of claim 32, the processing instructions further including transmitting a document to the client via the communication network.

34. The computer program product of claim 32, the processing instructions further including transmitting a document to a server via the communication network.

35. A computer program product embodying computer program instructions for execution by a computer, the computer program instructions comprising:
accepting an incoming document;
reading a personality document, the personality document including behavior document selection instructions for selecting a behavior document based on the incoming document, the behavior document containing processing instructions;
selecting a behavior document using the personality document behavior document selection instructions and the incoming document; and
processing the incoming document according to the processing instructions in the selected behavior document.

36. The computer program product of claim 35 wherein:
the personality document is a XML document; and
the selected behavior document is a XML document.

37. The computer program product of claim 35, wherein the selected behavior document processing instructions further include incoming document to working document translation instructions.

38. The computer program product of claim 35, wherein the selected behavior document processing instructions further include:
working document to outgoing document translation instructions; and
transmitting instructions for transmitting the outgoing document via a communication network.

39. The computer program product of claim 35, the computer program instructions further comprising transforming the incoming document into an incoming software object.

40. The computer program product of claim 35, wherein the selected behavior document processing instructions further include invoking a document parser.

41. A computer program product embodying computer program instructions for execution by a computer, the computer program instructions comprising:
receiving an incoming document sent by the client via the communication network;
reading a personality document, the personality document including:
behavior document selection instructions for selecting a behavior document based on the incoming document, the behavior document including processing instructions; and
translation document selection instructions for selecting a translation document based on the incoming document;
selecting a translation document using the personality document translation document selection instructions and the incoming document;
translating the incoming document into a working document using the selected translation document;
selecting a behavior document using the personality document behavior document selection instructions and the incoming document; and
processing the working document according to the processing instructions in the selected behavior document.

42. The computer program product of claim 41, wherein the selected behavior document processing instructions further include transmitting instructions for transmitting the working document via the communication network.

43. The computer program product of claim 41, wherein the selected behavior document processing instructions further include:
working document to outgoing document translation instructions; and
transmitting instructions for transmitting the outgoing document via the communication network.

44. The computer program product of claim 41, the computer program instructions further comprising transforming the working document into a working software object.

45. The data processing system of claim 41, the computer program instructions further comprising transforming the incoming document into an incoming software object.

46. The computer program product of claim 41, wherein the selected behavior document processing instructions further include invoking a document parser.

47. The computer program product of claim 41 wherein:
the serving document is a XML document; and
the selected behavior document is a XML document.

48. The computer program product of claim 41 wherein:
the incoming document is a XML document;
the working document is a XML document; and
the selected translation document is a XSLT document.
